(19) United States
(12) Patent Application Publication
(10) Pub. No.: US 2014/0288801 A1
(43) Pub. Date: Sep. 25, 2014

(54) CONTROL DEVICE AND CONTROL METHOD FOR VEHICLE

(71) Applicant: Toshitake Sasaki, Toyota-shi (JP)

(72) Inventor: Toshitake Sasaki, Toyota-shi (JP)

(73) Assignee: TOYOTA JIDOSHA KABUSHIKI KAISHA, Toyota-shi (JP)

(21) Appl. No.: 14/220,503

(22) Filed: Mar. 20, 2014

(30) Foreign Application Priority Data
Mar. 22, 2013 (JP) 2013-060029

(51) Int. Cl. F02D 41/00

(52) U.S. Cl. CPC F02D 41/0065
USPC 701/102

(57) ABSTRACT

A vehicle includes: an exhaust gas recirculation system in an internal combustion engine for recirculating part of exhaust gas to an intake passage of the internal combustion engine via a recirculation valve; and a cooling device for cooling recirculated gas, recirculated by the exhaust gas recirculation system, with refrigerant. An engine ECU informs a failure of the cooling device with a display unit when a cooling efficiency for cooling the recirculated gas, determined on the basis of a state value of the recirculated gas, becomes lower than a first determination value. The engine ECU additionally controls an opening degree of the recirculation valve such that an amount of the recirculated gas is reduced when the cooling efficiency for cooling the recirculated gas, determined on the basis of the state value of the recirculated gas, becomes lower than a second determination value lower than the first determination value.

### INCORPORATION BY REFERENCE

The disclosure of Japanese Patent Application No. 2013-060029 filed on Mar. 22, 2013 including the specification, drawings and abstract is incorporated herein by reference in its entirety.

### BACKGROUND OF THE INVENTION

1. Field of the Invention

The invention relates to a control device and control method for a vehicle on which an internal combustion engine is mounted as a power source and, more particularly, to control over a vehicle in the event of a failure in a cooler provided in an exhaust gas recirculation system.

2. Description of Related Art

There is a vehicle on which an internal combustion engine is mounted as a driving force source, the internal combustion engine including an exhaust gas recirculation (hereinafter, referred to as EGR) system that recirculates part of exhaust gas in an exhaust passage to an intake passage. The EGR system recirculates part of exhaust gas, which is emitted from the internal combustion engine, to an intake system, and mixes the recirculated exhaust gas with fresh air-fuel mixture, thus decreasing a combustion temperature. With this, generation of nitrogen oxides (NOx) is suppressed, and fuel economy is improved by suppressing a pumping loss.

The EGR system includes a cooling device (hereinafter, referred to as EGR cooler) for cooling EGR gas that is part of exhaust gas. The EGR cooler reduces a temperature difference between intake gas and EGR gas by cooling recirculated gas with the use of refrigerant (for example, engine coolant), with the result of a good combustion state. Thus, if there occurs a failure in the EGR cooler, the cooling efficiency for cooling EGR gas decreases, so it is not possible to adjust the temperature of EGR gas. As a result, the combustion state of the internal combustion engine may deteriorate. Components, such as an EGR valve and the intake passage, may thermally degrade upon reception of high-temperature EGR gas.

Japanese Patent Application Publication No. 2008-144609 (JP 2008-144609 A) describes a failure determination system for an EGR system. The failure determination system determines whether there is a failure in an EGR cooler. In the failure determination system, a temperature sensor that detects the temperature of EGR gas is provided in an EGR passage downstream of the EGR cooler. The failure determination system determines that the EGR cooler has a failure when the detected value of the temperature sensor is higher than or equal to a determination value. When it is determined that the EGR cooler has a failure, an error code is output or backup process, such as saving various data in the event of an abnormality, is executed as an EGR cooling system abnormality process. Because an exhaust gas treatment capacity decreases, output power is limited or an alarm lamp is illuminated.

In JP 2008-144609 A, by illuminating the alarm lamp that provides information about a failure of the EGR cooler, it is possible to prompt the user of the vehicle to take necessary measures, such as cleaning of the EGR cooler.

### SUMMARY OF THE INVENTION

When the cooling efficiency for cooling EGR gas is low and the EGR gas is in a high-temperature state, thermal degradation of the above-described components may advance, so it is desirable to quickly stop recirculation of EGR gas. When the degree of decrease in the cooling efficiency for cooling EGR gas is not determined, it is difficult to execute appropriate fail-safe process in the event of a failure in the EGR cooler in response to possible advancement of thermal degradation of the components.

The invention relates to a control device and control method for a vehicle, and appropriately executes fail-safe process in the event of a failure in a cooler provided in an exhaust gas recirculation system.

A first aspect of the invention provides a control device for a vehicle. The control device includes: an internal combustion engine mounted on the vehicle as a power source of the vehicle; an exhaust gas recirculation system provided in the internal combustion engine, the exhaust gas recirculation system being configured to recirculate part of exhaust gas from the internal combustion engine to an intake pipe of the internal combustion engine via a recirculation valve; a cooler provided in the internal combustion engine, the cooler being configured to cool recirculated gas, recirculated by the exhaust gas recirculation system, with the use of a refrigerant; and a controller configured to calculate a cooling efficiency for cooling the recirculated gas on the basis of a state value of the recirculated gas, the controller being configured to inform a failure of the cooler when the cooling efficiency becomes lower than a first determination value, the controller being configured to control the exhaust gas recirculation system such that an amount of the recirculated gas is reduced when the cooling efficiency for cooling the recirculated gas becomes lower than a second determination value lower than the first determination value.

In the control device according to the first aspect of the invention, the controller may be configured to calculate the cooling efficiency for cooling the recirculated gas on the basis of a state value including a temperature of the recirculated gas as the state value of the recirculated gas. In addition, the controller may be configured to inform a failure of the cooler when the temperature of the recirculated gas becomes higher than or equal to a first temperature. The controller may be configured to control the exhaust gas recirculation system such that the amount of the recirculated gas is reduced when the temperature of the recirculated gas becomes higher than or equal to a second temperature higher than the first temperature.

In addition, the controller may be configured to inform a failure of the cooler when a period during which the temperature of the recirculated gas is higher than or equal to the first temperature has reached a predetermined time.

In addition, the controller may be configured to inform a failure of the cooler when a frequency that the temperature of the recirculated gas becomes higher than or equal to the first temperature has reached a predetermined value.

In the control device according to the first aspect of the invention, the controller may be configured to calculate the cooling efficiency for cooling the recirculated gas on the basis of a state value including a pressure of the recirculated gas as the state value of the recirculated gas. In addition, the controller may be configured to inform a failure of the cooler when a pressure difference of the recirculated gas between an upstream side and downstream side of the cooler becomes smaller than or equal to a first value, and the controller may be configured to control the exhaust gas recirculation system such that the amount of the recirculated gas is reduced when the pressure difference of the recirculated gas becomes smaller than or equal to a second value smaller than the first value.

In addition, the controller may be configured to inform a failure of the cooler when a period during which the pressure difference of the recirculated gas is smaller, than or equal to the first value has reached a predetermined time.

In addition, the controller may be configured to inform a failure of the cooler when a frequency that the pressure difference of the recirculated gas becomes smaller than or equal to the first value has reached a predetermined value.

In the control device according to the first aspect of the invention, the controller may be configured to calculate the cooling efficiency for cooling the recirculated gas on the basis of a state value including a mass flow rate of the recirculated gas as the state value of the recirculated gas. In addition, the controller may be configured to inform a failure of the cooler when the mass flow rate of the recirculated gas that is delivered from the cooler becomes lower than or equal to a first value, and the controller may be configured to control the exhaust gas recirculation system such that the amount of the recirculated gas is reduced when the mass flow rate of the recirculated gas becomes lower than or equal to a second value lower than the first value.

In addition, the controller may be configured to inform a failure of the cooler when a period during which the mass flow rate of the recirculated gas is lower than or equal to the first value has reached a predetermined time.

In addition, the controller may be configured to inform a failure of the cooler when a frequency that the mass flow rate of the recirculated gas becomes lower than or equal to the first value has reached a predetermined value.

In the control device according to the first aspect of the invention, the controller may be configured to calculate the cooling efficiency for cooling the recirculated gas on the basis of a state value including a temperature of the refrigerant as the state value of the recirculated gas. In addition, the controller may be configured to inform a failure of the cooler when the temperature of the refrigerant becomes higher than or equal to a first temperature. The controller may be configured to control the exhaust gas recirculation system such that the amount of the recirculated gas is reduced when the temperature of the refrigerant becomes higher than or equal to a second temperature higher than the first temperature.

In addition, the controller may be configured to inform a failure of the cooler when a period during which the temperature of the refrigerant is higher than or equal to the first temperature has reached a predetermined time.

In addition, the controller may be configured to inform a failure of the cooler when a frequency that the temperature of the refrigerant becomes higher than or equal to the first temperature has reached a predetermined value.

A second aspect of the invention provides a control method for a vehicle including an internal combustion engine, an exhaust gas recirculation system, a cooler, and a controller, the internal combustion engine mounted on the vehicle as a power source of the vehicle. The control method includes: recirculating, by the exhaust gas recirculation system, part of exhaust gas from the internal combustion engine to an intake pipe of the internal combustion engine via a recirculation valve; cooling, by the cooler, the part of exhaust gas, recirculated to the intake pipe; calculating, by the controller, a cooling efficiency for cooling the recirculated gas on the basis of a state value of the recirculated gas; informing, by the controller, a failure of the cooler when the cooling efficiency becomes lower than a first determination value; and reducing, by the exhaust gas recirculation system, an amount of the recirculated gas when the cooling efficiency for cooling the recirculated gas becomes lower than a second determination value lower than the first determination value.

According to the invention, it is possible to appropriately execute fail-safe process in the event of a failure in the cooler provided in the exhaust gas recirculation system.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration view of a hybrid vehicle that is an example of a vehicle according to a first embodiment of the invention;

FIG. 2 is a schematic configuration view of an engine system that is controlled by an engine ECU;

FIG. 3 is an enlarged view of a portion corresponding to an EGR system in FIG. 2;

FIG. 4 is a flowchart that shows the procedure of determining a cooling efficiency for cooling EGR gas according to the first embodiment of the invention;

FIG. 5 is an enlarged view of a portion corresponding to an EGR system in a vehicle according to a second embodiment of the invention;

FIG. 6 is a flowchart that shows the procedure of determining a cooling efficiency for cooling EGR gas according to the second embodiment of the invention;

FIG. 7 is an enlarged view of a portion corresponding to an EGR system in a vehicle according to a third embodiment of the invention;

FIG. 8 is a flowchart that shows the procedure of determining a cooling efficiency for cooling EGR gas according to the third embodiment of the invention;

FIG. 9 is an enlarged view of a portion corresponding to an EGR system in a vehicle according to a fourth embodiment of the invention; and

FIG. 10 is a flowchart that shows the procedure of determining a cooling efficiency for cooling EGR gas according to the fourth embodiment of the invention.

### DETAILED DESCRIPTION OF EMBODIMENTS

Hereinafter, embodiments of the invention will be described in detail with reference to the accompanying drawings. Like reference numerals in the drawings denote the same or corresponding portions.

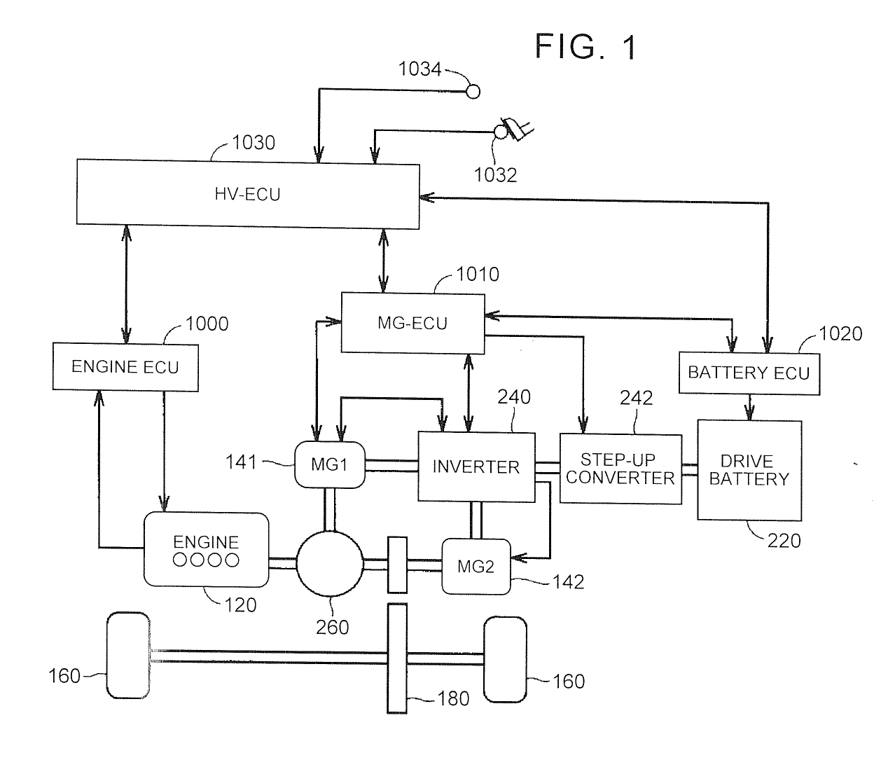

FIG. 1 is a schematic configuration view of a hybrid vehicle that is an example of a vehicle according to a first embodiment of the invention. The hybrid vehicle includes an internal combustion engine and a motor generator, and travels by controlling a driving force from the internal combustion engine and a driving force from the motor at an optimal ratio. The invention is applicable to any vehicle as long as the vehicle includes an internal combustion engine as a driving force source.

As shown in FIG. 1, the hybrid vehicle includes an internal combustion engine (engine) 120, a first motor generator (MG1) 141 and a second motor generator (MG2) 142. The engine 120 is, for example, a gasoline engine or a diesel engine, and includes a plurality of cylinders. For example, the engine 120 and the second motor generator 142 are used as driving force sources. That is, the hybrid vehicle travels on driving force from at least one of the engine 120 and the second motor generator 142. Each of the first motor generator 141 and the second motor generator 142 functions as a generator or functions as a motor in response to a traveling state of the hybrid vehicle.

The hybrid vehicle further includes a speed reducer 180, a power split mechanism 260, a drive battery 220, an inverter 240, a step-up converter 242, an engine electronic control unit (ECU) 1000, an MG-ECU 1010, a battery ECU 1020 and an HV-ECU 1030. The engine ECU 1000, the MG-ECU 1010, the battery ECU 1020 and the HV-ECU 1030 are configured to be able to mutually transmit and receive signals.

The speed reducer 180 transmits driving force, generated by the engine 120, the first motor generator 141 and the second motor generator 142, to drive wheels 160, and also transmits driving force from the drive wheels 160 to the engine 120, the first motor generator 141 and the second motor generator 142.

The power split mechanism 260 distributes driving force, generated by the engine 120, between two routes, that is, the first motor generator 141 and the drive wheels 160. For example, a planetary gear unit may be used as the power split mechanism 260. The engine 120 is coupled to a planetary carrier. The first motor generator 141 is coupled to a sun gear. The second motor generator 142 and an output shaft (drive wheels 160) are coupled to a ring gear. By controlling the rotation speed of the first motor generator 141, the power split mechanism 260 can function as a continuously variable transmission.

The drive battery 220 stores electric power for driving the first motor generator 141 and the second motor generator 142. The inverter 240 converts direct-current power from the drive battery 220 to alternating-current power or converts alternating-current power from the first motor generator 141 and the second motor generator 142 to direct-current power. The step-up converter 242 controls a charging/discharging state of the drive battery 220.

The HV-ECU 1030 controls an overall hybrid system such that the hybrid vehicle is able to travel most efficiently by managing the engine ECU 1000, the MG-ECU 1010 and the battery ECU 1020.

In FIG. 1, the ECUs are formed separately from one another. Instead, two or more of the ECUs may be formed of an integrated ECU. For example, an ECU that integrates the engine ECU 1000, the MG-ECU 1010 and the HV-ECU 1030 with one another may be used.

When the efficiency of the engine 120 at the time of a start of traveling, during low-speed traveling, or the like, the hybrid vehicle is controlled so as to travel on driving force from only the second motor generator 142.

During normal traveling, the hybrid vehicle is controlled so as to travel on driving force from both the engine 120 and the second motor generator 142. For example, the drive wheels 160 are driven by part of the driving force of the engine 120, split by the power split mechanism 260, and the first motor generator 141 is driven to generate electric power by the other part of the driving force of the engine 120. Thus, the engine 120 is assisted by the second motor generator 142.

During high-speed traveling, the output of the second motor generator 142 is increased by electric power supplied from the drive battery 220 to the second motor generator 142 such that driving force is added to the drive wheels 160.

During deceleration, the second motor generator 142 that is driven by the drive wheels 160 functions as a generator. Thus, regenerative power generation is carried out. Regenerated electric power is stored in the drive battery 220.

When the remaining level (state of charge (SOC)) of the drive battery 220 is low, the amount of electric power generated by the first motor generator 141 is increased by increasing the output of the engine 120. The drive battery 220 is charged with electric power generated by the first motor generator 141.

In the first embodiment of the invention, the HV-ECU 1030 sets a target power including a power (power that is calculated as the product of a torque and a rotation speed) required for the hybrid vehicle to travel, the amount of electric power with which the drive battery 220 is charged, and the like. The power required for the hybrid vehicle to travel is, for example, determined on the basis of an accelerator operation amount detected by an accelerator position sensor 1032 and a vehicle speed detected by a vehicle speed sensor 1034. Instead of the target power, a target driving force, a target acceleration, a target torque, or the like, may be determined.

The HV-ECU 1030 controls the engine ECU 1000, the MG-ECU 1010 and the battery ECU 1020 such that the target power is shared by the output power from the engine 120 and the output power from the second motor generator 142.

That is, the output power from the engine 120 and the output power from the second motor generator 142 are determined such that the sum of the output power from the engine 120 and the output power from the second motor generator 142 becomes the target power. Each of the engine 120 and the second motor generator 142 is controlled so as to achieve the corresponding predetermined output power.

Specifically, the engine 120 is controlled so as to achieve an engine torque and the output shaft rotation speed of the engine 120 (hereinafter, also referred to as engine rotation speed) by which fuel economy is predicted to be suitable for the power to be output from the engine 120. The engine torque and the engine rotation speed at which fuel economy is suitable are, for example, determined by a developer on the basis of results of an experiment, simulation, or the like, during development of the hybrid vehicle such that the best fuel economy is achieved within the range in which various conditions related to drivability, and the like, can be satisfied.

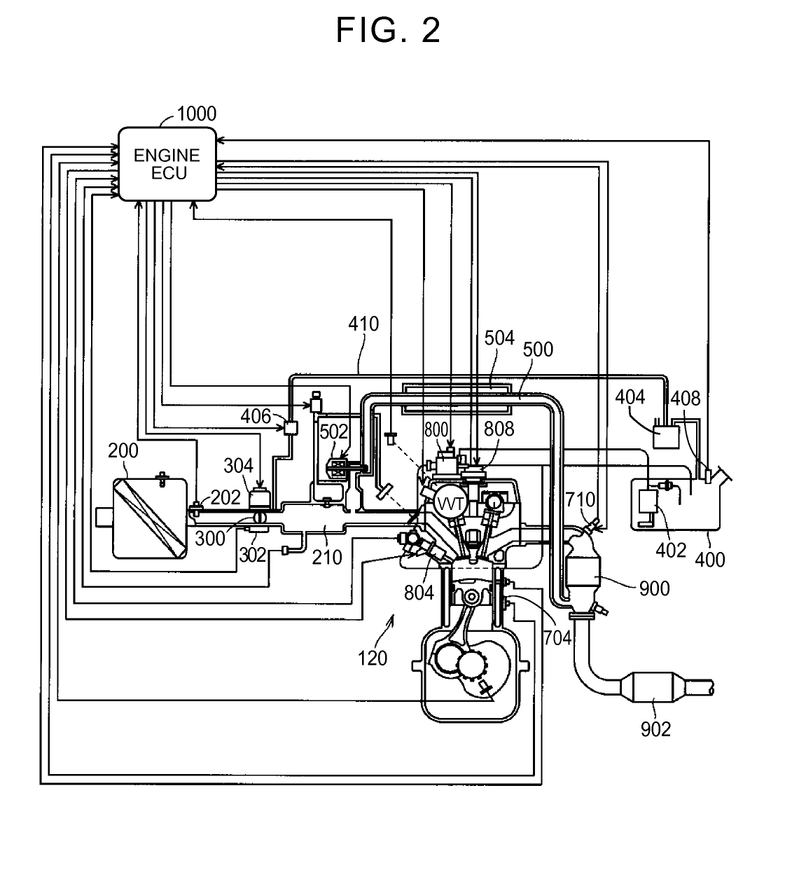

Next, the engine 120 that is controlled by the engine ECU 1000 will be described. FIG. 2 is a schematic configuration view of an engine system that is controlled by the engine ECU 1000.

As shown in FIG. 2, air taken in through an air cleaner 200 is introduced into combustion chambers of the engine 120 through an intake passage 210. An intake air amount is detected by an air flow meter 202, and a signal indicating the intake air amount is input to the engine ECU 1000. The intake air amount varies with the opening degree of a throttle valve 300. The opening degree of the throttle valve 300 is varied by a throttle motor 304. The throttle motor 304 operates on the basis of a signal from the engine ECU 1000. The opening degree of the throttle valve 300 is detected by a throttle position sensor 302, and a signal indicating the opening degree of the throttle valve 300 is input to the engine ECU 1000.

Fuel is stored in a fuel tank 400, and is injected from each injector 804 into a corresponding one of the combustion chambers by a fuel pump 402 via a high-pressure fuel pump 800. An air-fuel mixture of air introduced from an intake manifold and fuel injected from the fuel tank 400 into each of the combustion chambers via a corresponding one of the injectors 804 is ignited by a corresponding ignition plug 808.

Instead of or in addition to the direct-injection injector that injects fuel toward the inside of each cylinder, a port-injection injector that injects fuel toward an intake port may be provided.

Vaporized fuel from the fuel tank 400 is trapped by a charcoal canister 404. Vaporized fuel trapped by the charcoal canister 404 is purged to the intake passage 210, for example, when the pressure inside the fuel tank 400 exceeds a threshold. Purged vaporized fuel is introduced into the combustion chamber and is combusted.

A purge amount is controlled by a canister purging vacuum switching valve (VSV) 406 provided in a passage 410 that connects the charcoal canister 404 to the intake passage 210. When the canister purging VSV 406 opens, vaporized fuel is purged. When the canister purging VSV 406 closes, purging of vaporized fuel is stopped.

The canister purging VSV 406 is controlled by the engine ECU 1000. For example, the opening degree of the canister purging VSV 406 is controlled by a duty signal that is output from the engine ECU 1000 to the canister purging VSV 406.

The pressure inside the fuel tank 400 is detected by a pressure sensor 408, and a signal indicating the pressure is transmitted to the engine ECU 1000. The signal indicating the pressure inside the fuel tank 400 from the engine ECU 1000 is input to the HV-ECU 1030. In addition, signals indicating parameters of the operating state of the engine, such as the engine rotation speed, are input to the HV-ECU 1030 via the engine ECU 1000.

Exhaust gas passes through an exhaust manifold, passes through a catalyst 900 and a catalyst 902, and is emitted to the atmosphere. The catalysts 900, 902 exercise exhaust gas purification action at a predetermined temperature or higher and at a predetermined air-fuel ratio (for example, ideal air-fuel ratio) or smaller as is known.

Part of exhaust gas is recirculated to the intake passage 210 through an EGR pipe 500 of the EGR system. The flow rate of exhaust gas (hereinafter, also referred to as recirculated gas or EGR gas) that is recirculated by the EGR system is controlled by an EGR valve 502. The EGR system recirculates part of exhaust gas, which is emitted from the engine 120, to an intake system, and decreases a combustion temperature by mixing the exhaust gas with fresh air-fuel mixture, thus reducing unburned fuel, a pumping loss, nitrogen oxides (NOx), knocking, and the like.

An oxygen concentration of exhaust gas is detected by an air-fuel ratio sensor 710 for the purpose of air-fuel ratio feedback control, and a signal indicating the oxygen concentration is input to the engine ECU 1000.

In air-fuel ratio feedback control, when the air-fuel ratio is leaner than a stoichiometric air-fuel ratio, a fuel injection amount is corrected so as to increase. When the air-fuel ratio is richer than the stoichiometric air-fuel ratio, the fuel injection amount is corrected so as to reduce. A known technique may be utilized for air-fuel ratio feedback control, so the further detailed description thereof will not be repeated here.

The engine ECU 1000 calculates optimal ignition timing on the basis of the signals from the sensors, and outputs an ignition signal to each of the ignition plugs 808. For example, the ignition timing is calculated on the basis of an engine rotation speed, a cam position, an intake air amount, a throttle valve opening degree, an engine coolant temperature, and the like. The calculated ignition timing is corrected by a knock control system. When knocking has been detected by a knock sensor 704, the ignition timing is retarded in constant angles until knocking does not occur any more. On the other hand, when knocking does not occur any more, the ignition timing is advanced in constant angles.

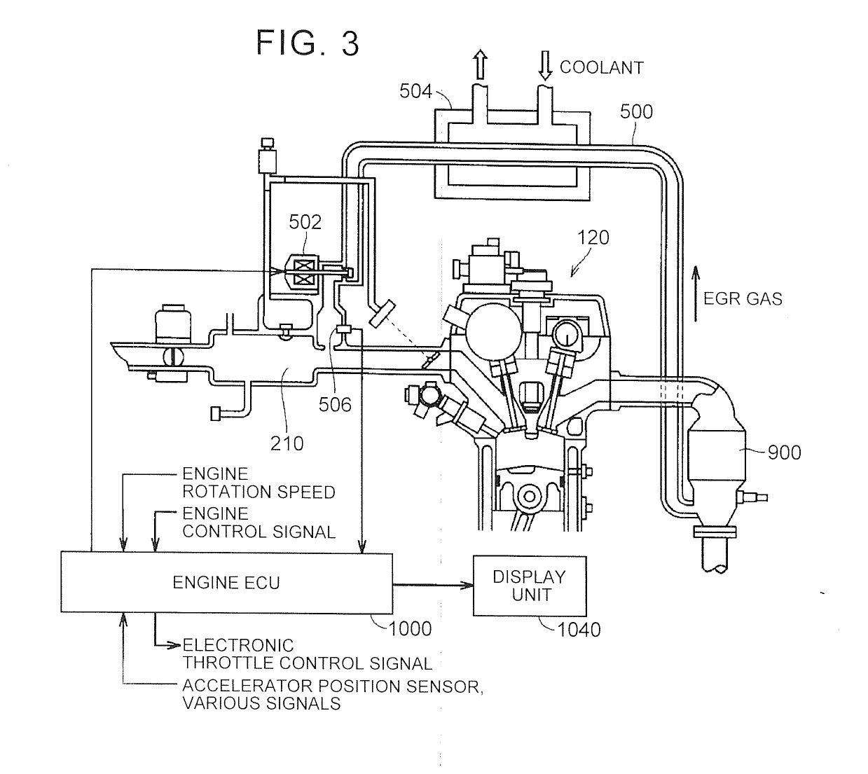

FIG. 3 is an enlarged view of a portion corresponding to the EGR system in FIG. 2. As shown in FIG. 3, part of exhaust gas (EGR gas) that has passed through the catalyst 900 passes through the EGR pipe 500 and is introduced to the EGR valve 502. The EGR valve 502 undergoes duty control by the engine ECU 1000. The engine ECU 1000 controls the opening degree of the EGR valve 502 on the basis of various signals, such as the engine rotation speed, the signal from the accelerator position sensor.

Although not shown in the drawing, the EGR valve 502 includes a stepping motor, a poppet valve and a return spring. The stepping motor operates on the basis of a control signal from the engine ECU 1000. The opening degree of the poppet valve is linearly controlled by the stepping motor. The EGR valve 503 is not limited to the configuration that the poppet valve is driven by the stepping motor. For example, the EGR valve 503 may be an EGR valve of a pneumatically controlled EGR formed of not an electric actuator, such as a stepping motor, but a pneumatic actuator including a solenoid valve and a diaphragm.

Because EGR gas that is recirculated to the combustion chambers has a high temperature, the EGR gas may adversely influence the performance of the engine 120 and the durability of the components. Therefore, a cooling device (hereinafter, also referred to as EGR cooler) 504 for cooling EGR gas is provided on the EGR pipe 500.

The EGR cooler 504 cools EGR gas with the use of engine coolant as refrigerant as an example. Specifically, the EGR cooler 504 includes a refrigerant introduction pipe and a refrigerant delivery pipe. The refrigerant introduction pipe introduces coolant into a refrigerant passage. The refrigerant delivery pipe delivers coolant from the refrigerant passage. EGR gas is cooled by heat exchange between coolant introduced into the refrigerant passage and the EGR gas. The illustrated configuration is that the refrigerant for EGR gas is engine coolant. Instead, the refrigerant may be another, such as air.

A signal indicating the engine rotation speed detected by an engine rotation speed sensor (not shown), that is, an engine control signal supplied from the HV-ECU 1030 (FIG. 1), is input to the engine ECU 1000. As described above, the engine control signal is a control signal that is generated by the HV-ECU 1030 on the basis of the target power determined on the basis of the accelerator operation amount and the vehicle speed, and, for example, includes a throttle opening degree signal.

The engine ECU 1000 generates an electronic throttle control signal on the basis of the engine control signal and other control signals, and outputs the electronic throttle control signal to the engine 120. The engine ECU 1000 generates a control signal for adjusting the opening degree of the EGR valve 502, and outputs the generated control signal to the stepping motor.

In the above-described EGR system, when there occurs a failure in the EGR cooler 504, the cooling efficiency for cooling EGR gas decreases. Therefore, a combustion state of the engine 120 may deteriorate due to recirculation of high-temperature EGR gas to the intake passage 210 via the EGR valve 502. There is also a concern that secondary damage, such as thermal degradation of the EGR valve 502 or the intake passage 210, is caused due to high-temperature EGR gas.

In the first embodiment of the invention, the engine ECU 1000 detects a state value of EGR gas during operation of the EGR system, and determines the cooling efficiency for cooling EGR gas on the basis of the detected state value. When it has been determined that the cooling efficiency for cooling EGR gas has decreased, a display unit 1040 and the EGR system are controlled on the basis of the degree of decrease in the cooling efficiency.

Specifically, the hybrid vehicle further includes the display unit 1040 as a user interface for showing information. The display unit 1040 includes an indicator, such as an indication lamp and an LED, a liquid crystal indicator, or the like. When it has been determined that the cooling efficiency for cooling EGR gas has decreased, the engine ECU 1000 informs a user of a failure of the EGR cooler 504 with the use of the display unit 1040. The display unit 1040 corresponds to “informing means”.

For example, when an alarm lamp is mounted as the display unit 1040, the engine ECU 1000 outputs a lighting command indicating an abnormality of the EGR cooler 504 to the display unit 1040. The display unit 1040 causes the alarm lamp to light up in response to the lighting command. Informing a failure of the EGR cooler 504 includes a text display on a liquid crystal indicator, voice message, and the like, other than lighting the alarm lamp.

The engine ECU 1000 generates a control signal for decreasing the opening degree of the EGR valve 502 and outputs the generated control signal to the stepping motor as fail safe at the time when the cooling efficiency for cooling EGR gas has decreased. When the-stepping motor decreases the opening degree of the EGR valve 502 upon reception of the control signal, the amount of EGR gas reduces. The fail-safe control also includes interrupting EGR gas by setting the EGR valve 502 in a closed state.

Hereinafter, determination as to the cooling efficiency for cooing EGR gas and fail-safe control at the time of a decrease in the cooling efficiency, which are executed by the engine ECU 1000, will be described in detail.

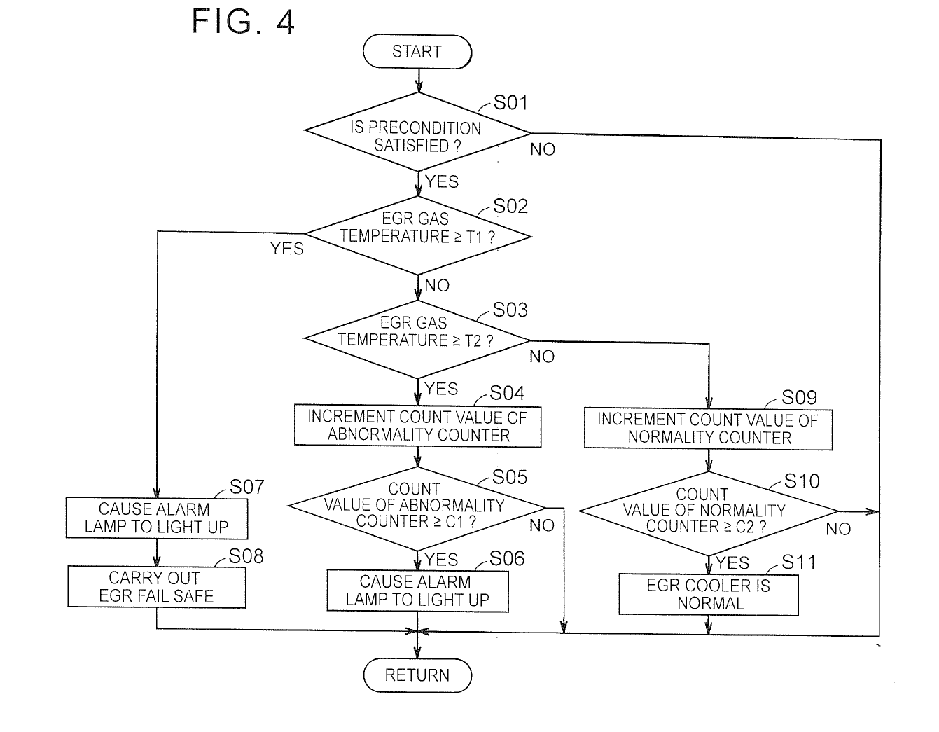

FIG. 4 is a flowchart that shows the procedure of determining the cooling efficiency for cooling EGR gas according to the first embodiment of the invention. The flowchart shown in FIG. 4 may be implemented by executing a prestored program in the engine ECU 1000.

As shown in FIG. 4, in step S01, initially, it is determined whether a precondition for executing the process of determining the cooling efficiency for cooling EGR gas is satisfied. The precondition defines that the combustion state of the engine 120 is stable and the EGR system is operating. This is because, during a transition, such as during starting of the engine 120 and during acceleration or deceleration of the vehicle, the amount and temperature of exhaust gas vary with a variation in the operating state of the engine 120 and, therefore, it is difficult to acquire a variation in the cooling efficiency for cooling EGR gas. Similarly, when the amount of EGR gas is small as well, it is difficult to accurately incorporate the cooling performance of the EGR cooler 504 into the state value of EGR gas. This precondition is, for example, determined by a developer on the basis of results of an experiment, simulation, or the like, in the vehicle by using the engine rotation speed, the engine load, the coolant temperature of the engine, the opening degree of the EGR valve 502, and the like, as parameters.

When it has been determined in step S01 that the precondition is not satisfied (NO in step S01), the process of determining the cooling efficiency for cooing EGR gas is not executed, and the process returns to the start. In contrast, when it has been determined that the precondition is satisfied (YES in step S01), the engine ECU 1000 determines the cooling efficiency for cooling EGR gas on the basis of the state value of EGR gas, detected by the various sensors.

In the first embodiment of the invention, the engine ECU 1000 detects the temperature of EGR gas that is delivered from the EGR cooler 504 as the state value of EGR gas. The temperature of EGR gas is detected by a temperature sensor 506 (FIG. 3) provided between the downstream side of the EGR valve 502 and the intake passage 210.

The engine ECU 1000 has a plurality of predetermined determination values, and compares the EGR gas temperature detected by the temperature sensor 506 with each of the plurality of determination values. The plurality of determination values are set in multiple steps such that it is possible to determine the degree of decrease in the cooling efficiency for cooling EGR gas. In the first embodiment of the invention, as an example, the engine ECU 1000 has two determination values T1, T2 (T2<T1). The determination value T1 corresponds to a temperature limit value in terms of specifications. When an increase in the temperature of EGR gas advances to the temperature limit value or higher, there is a concern that thermal degradation of the components, such as the EGR valve 502 and the intake passage 210, steeply advances. On the other hand, the determination value T2 corresponds to a temperature at which the possibility of thermal degradation of the above-described components is low but there is a concern that the performance of the engine 120 is adversely influenced. That is, the determination value T1 is a threshold for determining whether there is a concern that thermal degradation of the components advances, and the determination value T2 is a threshold for determining whether the performance of the engine 120 decreases.

In step S02, the engine ECU 1000 compares the detected value of the EGR gas temperature from the temperature sensor 506 with the determination value T1. When it has been determined that the EGR gas temperature is higher than or equal to the determination value T1 (YES in step S02), the engine ECU 1000 determines that there is a failure in the EGR cooler 504. In this case, the engine ECU 1000 outputs the lighting command indicating a failure of the EGR cooler 504 to the display unit 1040 in step S07. The display unit 1040 causes the alarm lamp to light up upon reception of the lighting command.

In addition, the engine ECU 1000 decreases the opening degree of the EGR valve 502 as fail safe in the event of a failure of the EGR cooler 504 in step S08. When the EGR gas amount reduces or EGR gas is interrupted, it is possible to prevent thermal degradation that the EGR valve 502 is exposed to high-temperature EGR gas and is stuck or the intake passage 210 erodes.

On the other hand, when it has been determined in step S02 that the EGR gas temperature is lower than the determination value T1 (NO in step S02), the engine ECU 1000 additionally compares the EGR gas temperature with the determination value T2 in step S03. The engine ECU 1000 increments two counters on the basis of the result of comparison between the EGR gas temperature and the determination value T2. The two counters include an abnormality counter for measuring a time during which the EGR gas temperature is higher than or equal to the determination value T2 and a normality counter for measuring a time during which the EGR gas temperature is lower than the determination value T2.

Specifically, when it has been determined that the EGR gas temperature is lower than the determination value T2 (NO in step S03), the engine ECU 1000 measures an elapsed time from the timing at which the process of determining the cooling efficiency for cooling EGR gas is started, that is, an elapsed time from when the precondition is satisfied in step S01. When the measured time has reached a predetermined time, the engine ECU 1000 increments the count value of the normality counter in step S09. The engine ECU 1000 proceeds to step S10, and determines whether the count value of the normality counter has reached a predetermined value C2. When the count value of the normality counter does not reach the predetermined value C2 (NO in step S10), the process returns to the start. On the other hand, when the count value of the normality counter has reached the predetermined value C2 (YES in step S10), the engine ECU 1000 determines in step S11 that the EGR cooler 504 is normal.

In contrast, when it has been determined that the EGR gas temperature is higher than or equal to the determination value T2 (YES in step S03), the engine ECU 1000 measures a time during which the EGR gas temperature is higher than or equal to the determination value T2 with the use of the abnormality counter. When the measured time has reached the predetermined time, the engine ECU 1000 increments the count value of the abnormality counter in step S04.

In step S05, the engine ECU 1000 determines whether the count value of the abnormality counter has reached the predetermined value C1. When the count value of the abnormality counter does not reach the predetermined value C1 (NO in step S05), the process returns to the start. On the other hand, when the count value of the abnormality counter has reached the predetermined value C1 (YES in step S05), the engine ECU 1000 determines that there is a failure in the EGR cooler 504. The engine ECU 1000 outputs the lighting command indicating a failure of the EGR cooler 504 to the display unit 1040 in step S06. The display unit 1040 causes the alarm lamp to light up upon reception of the lighting command.

In this way, with the vehicle according to the first embodiment of the invention, the engine ECU 1000 is able to determine the degree of decrease in the cooling efficiency for cooling EGR gas by comparing the detected value of the EGR gas temperature with each of the plurality of determination values set in multiple steps. Thus, in the event of a failure in the EGR cooler 504, it is possible to carry out necessary minimum fail safe by carrying out fail safe in stages on the basis of the degree of decrease in the cooling efficiency for cooling EGR gas.

More specifically, in the case of the first embodiment of the invention, the EGR gas amount is reduced (or EGR gas is interrupted) when it has been determined that there is a concern that thermal degradation of the EGR valve 502 and the intake passage 210 advances; whereas the EGR gas amount is not reduced and only information (causing the alarm lamp to light up) is provided to the user when it has been determined that there is no concern that such thermal degradation of the components advances. In this way, even when there occurs a failure in the EGR cooler 504, the EGR system is normally operated as long as thermal degradation of the EGR valve 502 and the intake passage 210 is not caused, so it is possible to continuously reduce unburned fuel, pumping loss, nitrogen oxides (NOx), knocking, and the like. As a result, it is possible to properly suppress thermal degradation of the components, such as the EGR valve 502 and the intake passage 210, while avoiding a frequent reduction in the EGR gas amount.

In the first embodiment of the invention, the cooling efficiency for cooling EGR gas is determined by using two-step determination values. Instead, it is possible to execute minute fail-safe control by using a more number of determination values. For example, by setting the amount of reduction in the EGR gas amount in stages on the basis of the degree of decrease in the cooling efficiency for cooling EGR gas, it is possible to continue the operation of the EGR system without degradation of the components.

In the process of determining the cooling efficiency for cooling EGR gas as shown in FIG. 4, a time during which the EGR gas temperature is higher than or equal to the determination value T2 is measured with the use of the abnormality counter. Instead, a frequency that the EGR gas temperature becomes higher than or equal to the determination value T2 may be measured with the use of the abnormality counter. In this case, when a frequency that the EGR gas temperature becomes higher than or equal to the determination value T2 has reached a predetermined value, the engine ECU 1000 increments the count value of the abnormality counter. In the former configuration that measures a time during which the EGR gas temperature is higher than or equal to the determination value T2, it is possible to accurately determine a decrease in the cooling efficiency for cooling EGR gas. In contrast, in the latter configuration that measures a frequency that the EGR gas temperature becomes higher than or equal to the determination value T2, it is possible to prevent steep advancement of thermal degradation of the components due to frequent repetition of a state where EGR gas becomes high temperature.

In the above-described vehicle according to the first embodiment of the invention, the configuration that determines the cooling efficiency for cooling EGR gas by using the EGR gas temperature that is detected by the temperature sensor 506 as the state value of EGR gas is described. Instead, the cooling efficiency for cooling EGR gas may be determined on the basis of a state value other than the EGR gas temperature. In a second embodiment of the invention, a configuration that determines the cooling efficiency for cooling EGR gas by using the pressure of EGR gas will be described.

The schematic configuration of the vehicle according to the second embodiment of the invention is similar to FIG. 1 and FIG. 2 except the control structure of the engine ECU 1000, so the detailed description will not be repeated.

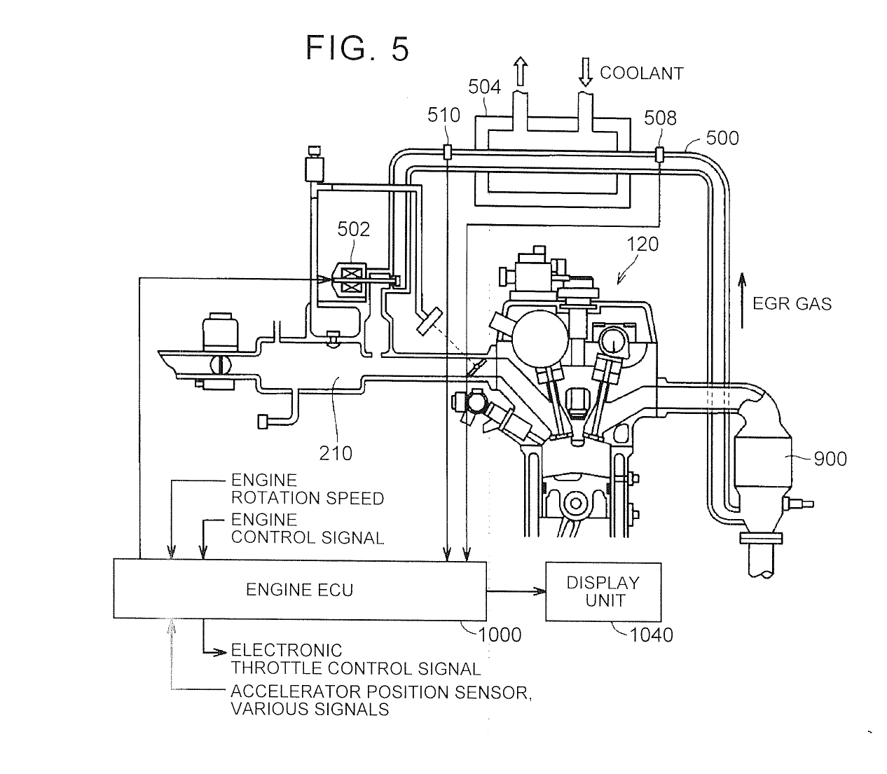

FIG. 5 is an enlarged view of a portion corresponding to the EGR system in the vehicle according to the second embodiment of the invention.

As shown in FIG. 5, the EGR system according to the second embodiment of the invention includes pressure sensors 508, 510 instead of the temperature sensor 506 in the EGR system shown in FIG. 3.

The pressure sensor 508 is provided upstream of the EGR cooler 504. The pressure sensor 508 detects the pressure of EGR gas that is introduced into the EGR cooler 504, and outputs the detected value to the engine ECU 1000. The pressure sensor 510 is provided downstream of the EGR cooler 504. The pressure sensor 510 detects the pressure of EGR gas that is delivered from the EGR cooler 504, and outputs the detected value to the engine ECU 1000.

The engine ECU 1000 calculates a difference between the detected value of the pressure from the pressure sensor 508 and the detected value of the pressure from the pressure sensor 510. The engine ECU 1000 determines the cooling efficiency for cooling EGR gas on the basis of the calculated pressure difference.

When the EGR cooler 504 is normal, EGR gas that has passed through the EGR cooler 504 is cooled and condensed. Therefore, a pressure loss of EGR gas flowing through the EGR pipe 500 reduces at the downstream side of the EGR cooler 504 as compared to the upstream side of the EGR cooler 504. Thus, the pressure of EGR gas, which is detected by the pressure sensor 510, becomes lower than the pressure of EGR gas, which is detected by the pressure sensor 508, so there is a pressure difference between the detected values of the two pressure sensors 508, 510.

In the second embodiment of the invention, the engine ECU 1000 detects the pressure difference of EGR gas during operation of the EGR system, and determines the cooling efficiency for cooling EGR gas on the basis of the detected pressure difference. When it has been determined that the cooling efficiency for cooling EGR gas has decreased, the display unit 1040 and the EGR system are controlled on the basis of the degree of decrease in the cooling efficiency as in the case of the first embodiment.

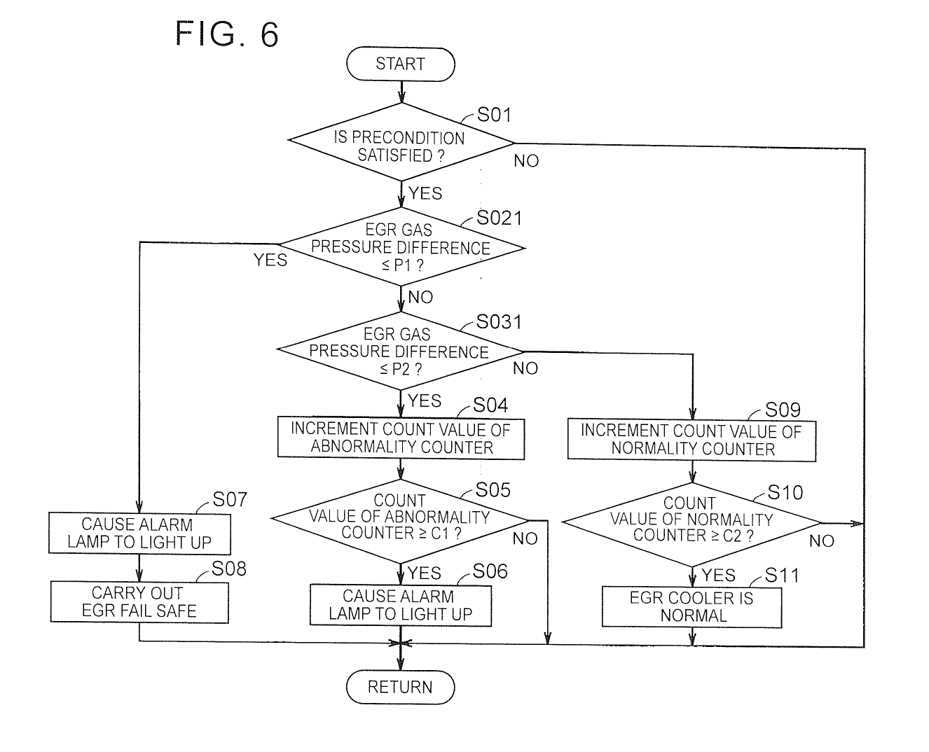

FIG. 6 is a flowchart that shows the procedure of determining the cooling efficiency for cooling EGR gas according to the second embodiment of the invention. The flowchart shown in FIG. 6 may be implemented by executing a prestored program in the engine ECU 1000.

As shown in FIG. 6, the engine ECU 1000 initially determines in step S01 similar to that of FIG. 4 whether the precondition is satisfied.

When it has been determined in step S01 that the precondition is not satisfied (NO in step S01), the process of determining the cooling efficiency for cooing EGR gas is not executed, and the process returns to the start. In contrast, when it has been determined that the precondition is satisfied (YES in step S01), the engine ECU 1000 determines the cooling efficiency for cooling EGR gas on the basis of the pressure difference of EGR gas between the upstream side and downstream side of the EGR cooler 504.

Specifically, the engine ECU 1000 detects the pressure of EGR gas that is introduced into the EGR cooler 504 with the use of the pressure sensor 508, and detects the pressure of EGR gas that is delivered from the EGR cooler 504 with the use of the pressure sensor 510. The engine ECU 1000 calculates a difference (pressure difference) between these two detected values.

The engine ECU 1000 has a plurality of predetermined determination values, and compares the calculated pressure difference of EGR gas with each of the plurality of determination values. The plurality of determination values are set in multiple steps such that it is possible to determine the degree of decrease in the cooling efficiency for cooling EGR gas. In the second embodiment, as an example, the engine ECU 1000 has two determination values P1, P2 (P1<P2). The determination value P1 corresponds to a pressure difference at a temperature limit value in terms of specifications. When an increase in the temperature of EGR gas advances to the temperature limit value or higher, there is a concern that thermal degradation of the EGR valve 502 and the intake passage 210 steeply advances. On the other hand, the determination value P2 corresponds to a pressure difference at a temperature at which the possibility of thermal degradation of the above-described components is low but there is a concern that the performance of the engine 120 is adversely influenced. That is, the determination value P1 is a threshold for determining whether there is a concern that thermal degradation of the components advances, and the determination value P2 is a threshold for determining whether the performance of the engine 120 decreases.

In step S021, the engine ECU 1000 compares the pressure difference of EGR gas, calculated from the detected values of the pressure sensors 508, 510, with the determination value P1. When it has been determined that the pressure difference of EGR gas is smaller than or equal to the determination value P1 (YES in step S021), the engine ECU 1000 determines that there is a failure in the EGR cooler 504. In step S07 and step S08 similar to those of FIG. 4, the engine ECU 1000 causes the alarm lamp of the display unit 1040 to light up, and reduces the EGR gas amount (or interrupts EGR gas) by decreasing the opening degree of the EGR valve 502.

On the other hand, when it has been determined in step S021 that the pressure difference of EGR gas is higher than the determination value P1 (NO in step S021), the engine ECU 1000 additionally compares the pressure difference of EGR gas with the determination value P2 in step S031. The engine ECU 1000 increments the abnormality counter or the normality counter on the basis of the result of comparison between the pressure difference of EGR gas and the determination value P2.

Specifically, when it has been determined that the pressure difference of EGR gas is larger than the determination value P2 (NO in step S031), the engine ECU 1000 measures an elapsed time from the timing at which the process of determining the cooling efficiency for cooling EGR gas is started, that is, an elapsed time from when the precondition is satisfied in step S01, in step S09 similar to that of FIG. 4. When the measured time has reached a predetermined time, the count value of the normality counter is incremented. In addition, the engine ECU 1000 determines that the EGR cooler 504 is normal when it has been determined that the count value of the normality counter has reached the predetermined value C2 in step S10 and step S11 similar to those of FIG. 4 (YES in step S10).

In contrast, when it has been determined that the pressure difference of EGR gas is smaller than or equal to the determination value P2 (YES in step S031), the engine ECU 1000 measures a time during which the pressure difference of EGR gas is smaller than or equal to the determination value P2 with the use of the abnormality counter and increments the count value of the abnormality counter when the measured time has reached the predetermined time in step S04 similar to that of FIG. 4.

When it has been determined that the count value of the abnormality counter has reached the predetermined value C1 in step S05 and step S06 similar to those of FIG. 4 (YES in step S05), the engine ECU 1000 determines that there is a failure in the EGR cooler 504. The engine ECU 1000 causes the alarm lamp of the display unit 1040 to light up in step S06 similar to that of FIG. 4.

In this way, with the vehicle according to the second embodiment of the invention, the engine ECU 1000 is able to determine the degree of decrease in the cooling efficiency for cooling EGR gas by comparing the pressure difference of EGR gas between the upstream side and downstream side of the EGR cooler 504 with each of the plurality of determination values set in multiple steps. Thus, as in the case of the first embodiment, in the event of a failure in the EGR cooler 504, it is possible to carry out necessary minimum fail safe by carrying out fail safe in stages on the basis of the degree of decrease in the cooling efficiency for cooling EGR gas.

In the process of determining the cooling efficiency for cooling EGR gas as shown in FIG. 6, a time during which the pressure difference of EGR gas is smaller than or equal to the determination value P2 is measured with the use of the abnormality counter. Instead, a frequency that the pressure difference of EGR gas becomes smaller than or equal to the determination value P2 may be measured with the use of the abnormality counter. In this case, when a frequency that the pressure difference of EGR gas is smaller than or equal to the determination value P2 has reached the predetermined value, the engine ECU 1000 increments the count value of the abnormality counter.

In a third embodiment of the invention, a configuration that determines the cooling efficiency for cooling EGR gas by using the flow rate (mass flow rate) of EGR gas that is delivered from the EGR cooler 504 will be described. The schematic configuration of the vehicle according to the third embodiment of the invention is similar to FIG. 1 and

FIG. 2 except the control structure of the engine ECU 1000, so the detailed description will not be repeated.

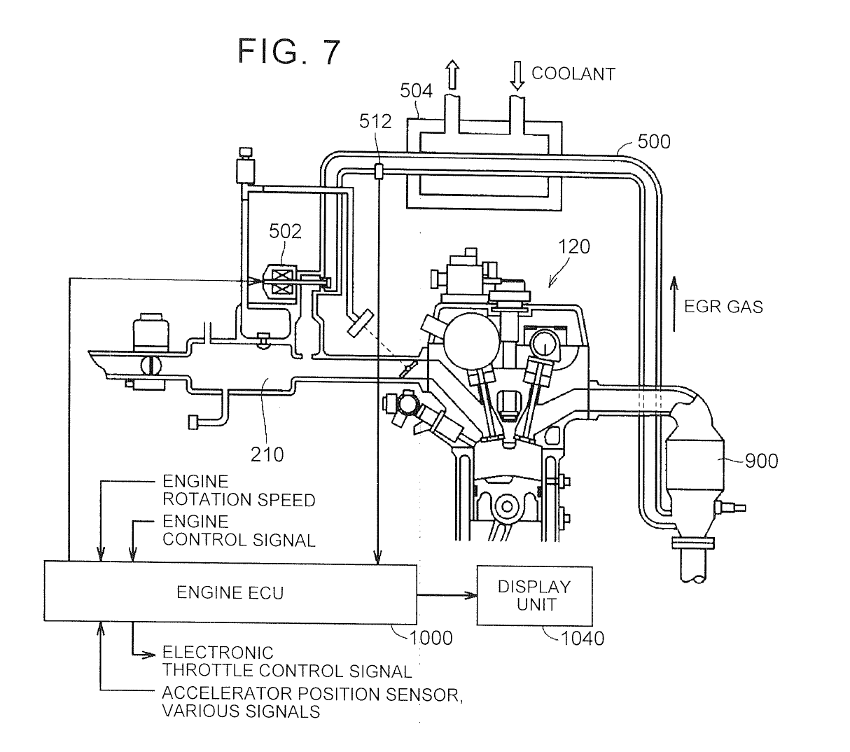

FIG. 7 is an enlarged view of a portion corresponding to the EGR system in the vehicle according to the third embodiment of the invention.

As shown in FIG. 7, the EGR system according to the third embodiment of the invention includes a flow rate sensor 512 instead of the temperature sensor 506 in the EGR system shown in FIG. 3.

The flow rate sensor 512 is provided downstream of the EGR cooler 504. The flow rate sensor 512 detects the mass flow rate of EGR gas that is delivered from the EGR cooler 504, and outputs the detected value to the engine ECU 1000.

The engine ECU 1000 determines the cooling efficiency for cooling EGR gas on the basis of the detected value from the flow rate sensor 512 during EGR operation. When it has been determined that the cooling efficiency for cooling EGR gas has decreased, the display unit 1040 and the EGR system are controlled on the basis of the degree of decrease in the cooling efficiency as in the case of the first embodiment.

As described above, when the EGR cooler 504 is normal, EGR gas that has passed through the EGR cooler 504 is cooled and condensed, so the mass flow rate increases. In the third embodiment, the engine ECU 1000 detects the mass flow rate of EGR gas during operation of the EGR system, and determines the cooling efficiency for cooling EGR gas on the basis of the detected mass flow rate. When it has been determined that the cooling efficiency for cooling EGR gas has decreased, the display unit 1040 and the EGR system are controlled on the basis of the degree of decrease in the cooling efficiency as in the case of the first embodiment.

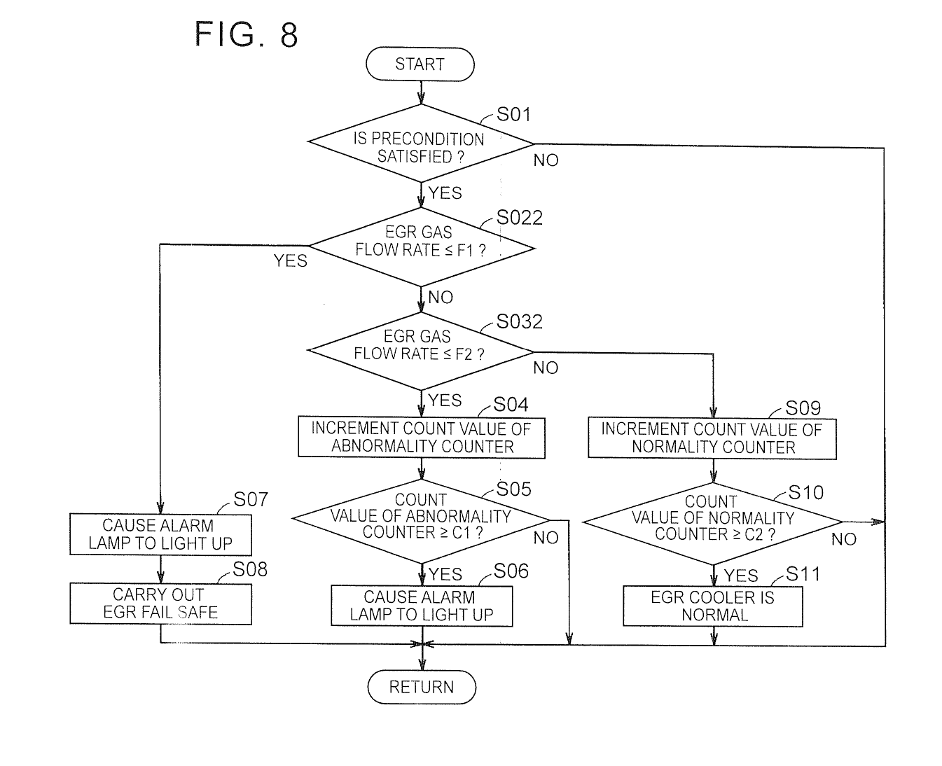

FIG. 8 is a flowchart that shows the procedure of determining the cooling efficiency for cooling EGR gas according to the third embodiment of the invention. The flowchart shown in FIG. 8 may be implemented by executing a prestored program in the engine ECU 1000.

As shown in FIG. 8, the engine ECU 1000 initially determines in step S01 similar to that of FIG. 4 whether the precondition is satisfied.

When it has been determined in step S01 that the precondition is not satisfied (NO in step S01), the process of determining the cooling efficiency for cooing EGR gas is not executed, and the process returns to the start. In contrast, when it has been determined that the precondition is satisfied (YES in step S01), the engine ECU 1000 determines the cooling efficiency for cooing EGR gas on the basis of the mass flow rate of EGR gas at a portion downstream of the EGR cooler 504.

Specifically, the engine ECU 1000 detects the mass flow rate of EGR gas that is delivered from the EGR cooler 504 with the use of the flow rate sensor 512. The engine ECU 1000 has a plurality of predetermined determination values, and compares the detected mass flow rate of EGR gas with each of the plurality of determination values. The plurality of determination values are set in multiple steps such that it is possible to determine the degree of decrease in the cooling efficiency for cooling EGR gas. In the third embodiment, as an example, the engine ECU 1000 has two determination values F1, F2 (F1<F2). The determination value F1 corresponds to a mass flow rate at a temperature limit value in terms of specifications. When an increase in the temperature of EGR gas advances to the temperature limit value or higher, there is a concern that thermal degradation of the EGR valve 502 and the intake passage 210 steeply advances. On the other hand, the determination value F2 corresponds to a mass flow rate at which the possibility of thermal degradation of the above-described components is low but there is a concern that the performance of the engine 120 is adversely influenced. That is, the determination value F1 is a threshold for determining whether there is a concern that thermal degradation of the components advances, and the determination value F2 is a threshold for determining whether the performance of the engine 120 decreases.

In step S022, the engine ECU 1000 compares the detected value of the mass flow rate of EGR gas from the flow rate sensor 512 with the determination value F1. When it has been determined that the mass flow rate of EGR gas is lower than or equal to the determination value F1 (YES in step S022), the engine ECU 1000 determines that there is a failure in the EGR cooler 504. In step S07 and step S08 similar to those of FIG. 4, the engine ECU 1000 causes the alarm lamp of the display unit 1040 to light up, and reduces the EGR gas amount by decreasing the opening degree of the EGR valve 502.

On the other hand, when it has been determined in step S022 that the mass flow rate of EGR gas is higher than the determination value F1 (NO in step S022), the engine ECU 1000 additionally compares the mass flow rate of EGR gas with the determination value F2 in step S032. The engine ECU 1000 increments the abnormality counter or the normality counter on the basis of the result of comparison between the mass flow rate of EGR gas and the determination value F2.

Specifically, when it has been determined that the mass flow rate of EGR gas is higher than the determination value F2 (NO in step S032), the engine ECU 1000 measures an elapsed time from the timing at which the process of determining the cooling efficiency for cooling EGR gas is started, that is, an elapsed time from when the precondition is satisfied in step S01, in step S09 similar to that of FIG. 4. When the measured time has reached a predetermined time, the count value of the normality counter is incremented. In addition, the engine ECU 1000 determines that the EGR cooler 504 is normal when it has been determined that the count value of the normality counter has reached the predetermined value C2 in step S10 and step S11 similar to those of FIG. 4 (YES in step S10).

In contrast, when it has been determined that the mass flow rate of EGR gas is lower than or equal to the determination value F2 (YES in step S032), the engine

ECU 1000 measures a time during which the mass flow rate of EGR gas is lower than or equal to the determination value F2 with the use of the abnormality counter and increments the count value of the abnormality counter when the measured time has reached the predetermined time in step S04 similar to that of FIG. 4.

When it has been determined that the count value of the abnormality counter has reached the predetermined value C1 in step S05 and step S06 similar to those of FIG. 4 (YES in step S05), the engine ECU 1000 determines that there is a failure in the EGR cooler 504. The engine ECU 1000 causes the alarm lamp of the display unit 1040 to light up in step S06 similar to that of FIG. 4.

In this way, with the vehicle according to the third embodiment of the invention, the engine ECU 1000 is able to determine the degree of decrease in the cooling efficiency for cooling EGR gas by comparing the mass flow rate of EGR gas that is delivered from the EGR cooler 504 with each of the plurality of determination values set in multiple steps. Thus, as in the case of the first embodiment, in the event of a failure in the EGR cooler 504, it is possible to carry out necessary minimum fail safe by carrying out fail safe in stages on the basis of the degree of decrease in the cooling efficiency for cooling EGR gas.

In the process of determining the cooling efficiency for cooling EGR gas as shown in FIG. 8, a time during which the mass flow rate of EGR gas is lower than or equal to the determination value F2 is measured with the use of the abnormality counter. Instead, a frequency that the mass flow rate of EGR gas becomes lower than or equal to the determination value F2 may be measured with the use of the abnormality counter. In this case, when a frequency that the mass flow rate of EGR gas becomes lower than or equal to the determination value F2 has reached the predetermined value, the engine ECU 1000 increments the count value of the abnormality counter.

In a fourth embodiment of the invention, a configuration that determines the cooling efficiency for cooling EGR gas by using the temperature of engine coolant that is used as refrigerant for EGR gas will be described. The schematic configuration of the vehicle according to the fourth embodiment of the invention is similar to FIG. 1 and FIG. 2 except the control structure of the engine ECU 1000, so the detailed description will not be repeated.

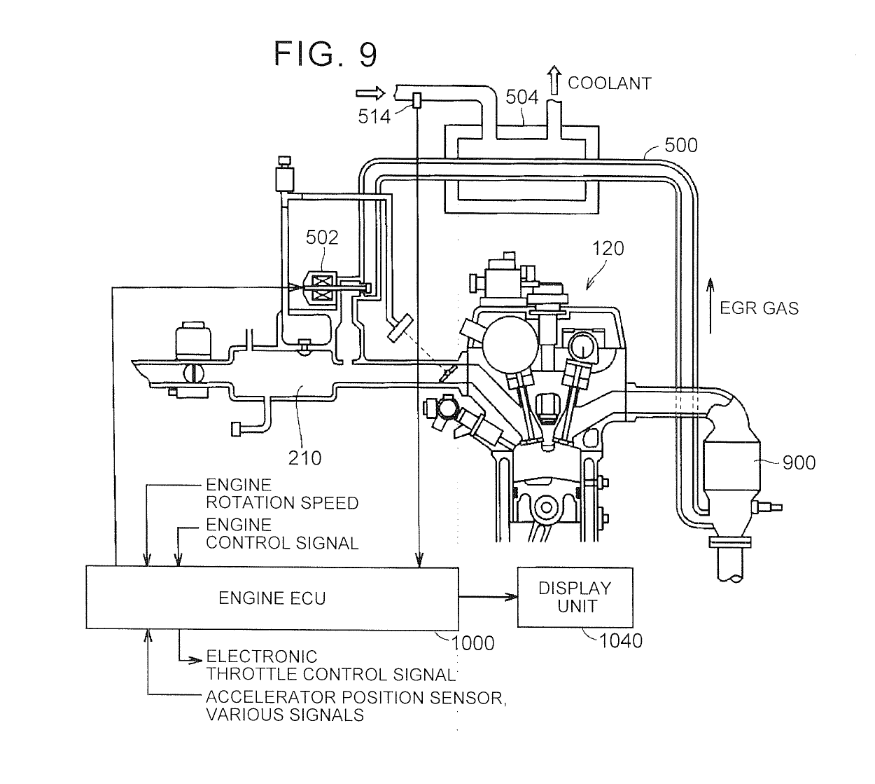

FIG. 9 is an enlarged view of a portion corresponding to the EGR system in the vehicle according to the fourth embodiment of the invention.

As shown in FIG. 9, the EGR system according to the fourth embodiment of the invention includes a temperature sensor 514 instead of the temperature sensor 506 in the EGR system shown in FIG. 3.

The temperature sensor 514 is provided on a refrigerant introduction pipe of the EGR cooler 504, detects the temperature of coolant that is introduced into the EGR cooler 504, and outputs the detected value to the engine ECU 1000.

The engine ECU 1000 determines the cooling efficiency for cooling EGR gas on the basis of the detected value from the temperature sensor 514 during EGR operation. When it has been determined that the cooling efficiency for cooling EGR gas has decreased, the display unit 1040 and the EGR system are controlled on the basis of the degree of decrease in the cooling efficiency.

The engine coolant circulates between the engine 120 and a radiator (not shown). Coolant that has absorbed heat of the engine 120 is transferred to the radiator, and is cooled by radiating heat at the radiator. After that, the coolant is returned to the engine 120 again. Part of the coolant is introduced into the EGR cooler 504. Therefore, if engine coolant is returned to the engine 120 without being sufficiently cooled at the radiator, the cooling efficiency for cooling the engine 120 decreases, and the cooling efficiency for cooling EGR gas also decreases. In the fourth embodiment, the engine ECU 1000 detects the temperature of coolant that is introduced into the EGR cooler 504 during operation of the EGR system, and determines the cooling efficiency for cooling EGR gas on the basis of the detected temperature of coolant. When it has been determined that the cooling efficiency for cooling EGR gas has decreased, the display unit 1040 and the EGR system are controlled on the basis of the degree of decrease in the cooling efficiency as in the case of the first embodiment.

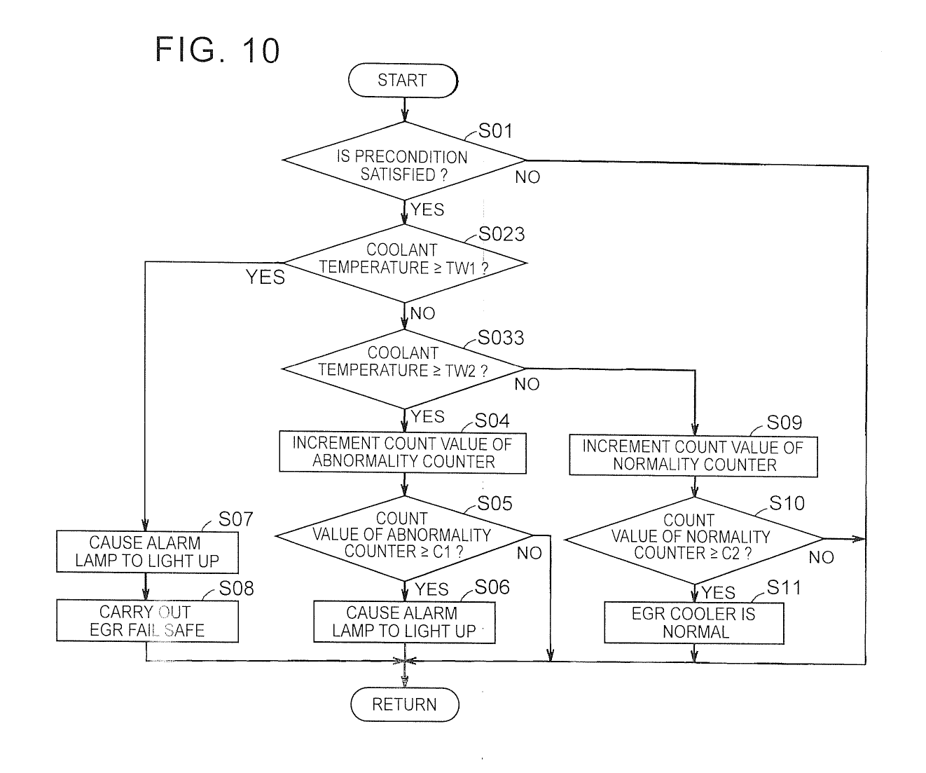

FIG. 10 is a flowchart that shows the procedure of determining the cooling efficiency for cooling EGR gas according to the fourth embodiment of the invention. The flowchart shown in FIG. 10 may be implemented by executing a prestored program in the engine ECU 1000.

As shown in FIG. 10, the engine ECU 1000 initially determines in step S01 similar to that of FIG. 4 whether the precondition is satisfied.

When it has been determined in step S01 that the precondition is not satisfied (NO in step S01), the process of determining the cooling efficiency for cooing EGR gas is not executed, and the process returns to the start. In contrast, when it has been determined that the precondition is satisfied (YES in step S01), the engine ECU 1000 determines the cooling efficiency for cooing EGR gas on the basis of the temperature of coolant that is introduced into the EGR cooler 504.

Specifically, the engine ECU 1000 detects the temperature of coolant that is introduced into the EGR cooler 504 with the use of the temperature sensor 514. The engine ECU 1000 has a plurality of predetermined determination values, and compares the detected temperature of coolant with each of the plurality of determination values. The plurality of determination values are set in multiple steps such that it is possible to determine the degree of decrease in the cooling efficiency for cooling EGR gas. In the fourth embodiment, as an example, the engine ECU 1000 has two determination values TW1, TW2 (TW1>TW2). The determination value TW1 corresponds to a coolant temperature at a temperature limit value in terms of specifications. When an increase in the temperature of EGR gas advances to the temperature limit value or higher, there is a concern that thermal degradation of the EGR valve 502 and the intake passage 210 steeply advances. On the other hand, the determination value TW2 corresponds to a coolant temperature at a temperature at which the possibility of thermal degradation of the above-described components is low but there is a concern that the performance of the engine 120 is adversely influenced. That is, the determination value TW1 is a threshold for determining whether there is a concern that thermal degradation of the components advances, and the determination value TW2 is a threshold for determining whether the performance of the engine 120 decreases.

In step S023, the engine ECU 1000 compares the detected value of the coolant temperature from the temperature sensor 514 with the determination value TW1. When it has been determined that the coolant temperature is higher than or equal to the determination value TW1 (YES in step S023), the engine ECU 1000 determines that there is a failure in the EGR cooler 504. In step S07 and step S08 similar to those of FIG. 4, the engine ECU 1000 causes the alarm lamp of the display unit 1040 to light up, and reduces the EGR gas amount by decreasing the opening degree of the EGR valve 502.

On the other hand, when it has been determined in step S023 that the coolant temperature is lower than the determination value TW1 (NO in step S023), the engine ECU 1000 additionally compares the coolant temperature with the determination value TW2 in step S033. The engine ECU 1000 increments the abnormality counter or the normality counter on the basis of the result of comparison between the coolant temperature and the determination value TW2.

Specifically, when it has been determined that the coolant temperature is lower than the determination value TW2 (NO in step S033), the engine ECU 1000 measures an elapsed time from the timing at which the process of determining the cooling efficiency for cooling EGR gas is started, that is, an elapsed time from when the precondition is satisfied in step S01, in step S09 similar to that of FIG. 4. When the measured time has reached a predetermined time, the count value of the normality counter is incremented. In addition, the engine ECU 1000 determines that the EGR cooler 504 is normal when it has been determined that the count value of the normality counter has reached the predetermined value C2 in step S10 and step S11 similar to those of FIG. 4 (YES in step S10).

In contrast, when it has been determined that the coolant temperature is higher than or equal to the determination value TW2 (YES in step S033), the engine ECU 1000 measures a time during which the coolant temperature is higher than or equal to the determination value TW2 with the use of the abnormality counter and increments the count value of the abnormality counter when the measured time has reached the predetermined time in step S04 similar to that of FIG. 4.

When it has been determined that the count value of the abnormality counter has reached the predetermined value C1 in step S05 and step S06 similar to those of FIG. 4 (YES in step S05), the engine ECU 1000 determines that there is a failure in the EGR cooler 504. The engine ECU 1000 causes the alarm lamp of the display unit 1040 to light up in step S06 similar to that of FIG. 4.

In this way, with the vehicle according to the fourth embodiment of the invention, the engine ECU 1000 is able to determine the degree of decrease in the cooling efficiency for cooling EGR gas by comparing the temperature of coolant that is introduced into the EGR cooler 504 with each of the plurality of determination values set in multiple steps. Thus, as in the case of the first embodiment, in the event of a failure in the EGR cooler 504, it is possible to carry out necessary minimum fail safe by carrying out fail safe in stages on the basis of the degree of decrease in the cooling efficiency for cooling EGR gas.

In the process of determining the cooling efficiency for cooling EGR gas as shown in FIG. 10, a time during which the coolant temperature is higher than or equal to the determination value TW2 is measured with the use of the abnormality counter. Instead, a frequency that the coolant temperature becomes higher than or equal to the determination value TW2 may be measured with the use of the abnormality counter. In this case, when a frequency that the coolant temperature becomes higher than or equal to the determination value TW2 has reached a predetermined value, the engine ECU 1000 increments the count value of the abnormality counter.

In the above-described first to fourth embodiments of the invention, as an example of the vehicle, the hybrid vehicle that includes the engine and the motor generator as power sources is described. Instead, the invention is applicable to a vehicle as long as the vehicle includes an engine. For example, the invention is applicable to an ordinary engine vehicle and a vehicle having a hybrid configuration different from the hybrid configuration shown in FIG. 1.

However, when the invention is applied to the hybrid vehicle, it is possible to provide the opportunity for executing the process of determining the cooling efficiency for cooling EGR gas, that is, the opportunity that the precondition is satisfied, independent of generation of vehicle driving force. Thus, for example, in a so-called plug-in hybrid vehicle in which an in-vehicle electrical storage device (drive battery 220) is chargeable from an external power supply, the cooling efficiency for cooling EGR gas may be determined by operating the engine while the electrical storage device is being charged from the external power supply. In this case, it is possible to charge the electrical storage device with electric power generated by the first motor generator 141 by using the output of the engine.

In the first to fourth embodiments of the invention, the configuration that detects the EGR gas temperature, the mass flow rate of EGR gas or the engine coolant temperature as the state value of EGR gas and determines the cooling efficiency for cooling EGR gas on the basis of the individual detected value is described. Instead, a configuration that determines the cooling efficiency for cooling EGR gas on the basis of at least one combination of these detected values may be employed.

The embodiments described above are illustrative and not restrictive in all respects. The scope of the invention is defined by the appended claims rather than the above description. The scope of the invention is intended to encompass all modifications within the scope of the appended claims and equivalents thereof.

What is claimed is:

1. A control device for a vehicle, comprising:
an internal combustion engine mounted on the vehicle as a power source of the vehicle;
an exhaust gas recirculation system provided in the internal combustion engine, the exhaust gas recirculation system being configured to recirculate part of exhaust gas from the internal combustion engine to an intake pipe of the internal combustion engine via a recirculation valve;
a cooler provided in the internal combustion engine, the cooler being configured to cool recirculated gas, recirculated by the exhaust gas recirculation system, with the use of a refrigerant; and
a controller configured to calculate a cooling efficiency for cooling the recirculated gas on the basis of a state value of the recirculated gas, the controller being configured to inform a failure of the cooler when the cooling efficiency becomes lower than a first determination value, the controller being configured to control the exhaust gas recirculation system such that an amount of the recirculated gas is reduced when the cooling efficiency for cooling the recirculated gas becomes lower than a second determination value lower than the first determination value.

2. The control device according to claim 1, wherein
the controller is configured to calculate the cooling efficiency for cooling the recirculated gas on the basis of a state value including a temperature of the recirculated gas as the state value of the recirculated gas.

3. The control device according to claim 2, wherein
the controller is configured to inform a failure of the cooler when the temperature of the recirculated gas becomes higher than or equal to a first temperature, and the controller is configured to control the exhaust gas recirculation system such that the amount of the recirculated gas is reduced when the temperature of the recirculated gas becomes higher than or equal to a second temperature higher than the first temperature.

4. The control device according to claim 3, wherein
the controller is configured to inform a failure of the cooler when a period during which the temperature of the recirculated gas is higher than or equal to the first temperature has reached a predetermined time.

5. The control device according to claim 3, wherein
the controller is configured to inform a failure of the cooler when a frequency that the temperature of the recirculated gas becomes higher than or equal to the first temperature has reached a predetermined value.

6. The control device according to claim 1, wherein
the controller is configured to calculate the cooling efficiency for cooling the recirculated gas on the basis of a state value including a pressure of the recirculated gas as the state value of the recirculated gas.

7. The control device according to claim 6, wherein
the controller is configured to inform a failure of the cooler when a pressure difference of the recirculated gas between an upstream side and downstream side of the cooler becomes smaller than or equal to a first value, and the controller is configured to control the exhaust gas recirculation system such that the amount of the recirculated gas is reduced when the pressure difference of the recirculated gas becomes smaller than or equal to a second value smaller than the first value.

8. The control device according to claim 7, wherein
the controller is configured to inform a failure of the cooler when a period during which the pressure difference of the recirculated gas is smaller than or equal to the first value has reached a predetermined time.

9. The control device according to claim 7, wherein
the controller is configured to inform a failure of the cooler when a frequency that the pressure difference of the recirculated gas becomes smaller than or equal to the first value has reached a predetermined value.

10. The control device according to claim 1, wherein
the controller is configured to calculate the cooling efficiency for cooling the recirculated gas on the basis of a state value including a mass flow rate of the recirculated gas as the state value of the recirculated gas.

11. The control device according to claim 10, wherein
the controller is configured to inform a failure of the cooler when the mass flow rate of the recirculated gas that is delivered from the cooler becomes lower than or equal to a first value, and the controller is configured to control the exhaust gas recirculation system such that the amount of the recirculated gas is reduced when the mass flow rate of the recirculated gas becomes lower than or equal to a second value lower than the first value.

12. The control device according to claim 11, wherein
the controller is configured to inform a failure of the cooler when a period during which the mass flow rate of the recirculated gas is lower than or equal to the first value has reached a predetermined time.

13. The control device according to claim 11, wherein
the controller is configured to inform a failure of the cooler when a frequency that the mass flow rate of the recirculated gas becomes lower than or equal to the first value has reached a predetermined value.

14. The control device according to claim 1, wherein
the controller is configured to calculate the cooling efficiency for cooling the recirculated gas on the basis of a state value including a temperature of the refrigerant as the state value of the recirculated gas.

15. The control device according to claim 14, wherein
the controller is configured to inform a failure of the cooler when the temperature of the refrigerant becomes higher than or equal to a first temperature, and the controller is configured to control the exhaust gas recirculation system such that the amount of the recirculated gas is reduced when the temperature of the refrigerant becomes higher than or equal to a second temperature higher than the first temperature.

16. The control device according to claim 15, wherein
the controller is configured to inform a failure of the cooler when a period during which the temperature of the refrigerant is higher than or equal to the first temperature has reached a predetermined time.

17. The control device according to claim 15, wherein
the controller is configured to inform a failure of the cooler when a frequency that the temperature of the refrigerant becomes higher than or equal to the first temperature has reached a predetermined value.

18. A control method for a vehicle including an internal combustion engine, an exhaust gas recirculation system, a cooler, and a controller, the internal combustion engine mounted on the vehicle as a power source of the vehicle,
the control method comprising:
recirculating, by the exhaust gas recirculation system, part of exhaust gas from the internal combustion engine to an intake pipe of the internal combustion engine via a recirculation valve;
cooling, by the cooler, the part of exhaust gas, recirculated to the intake pipe;
calculating, by the controller, a cooling efficiency for cooling the recirculated gas on the basis of a state value of the recirculated gas;
informing, by the controller, a failure of the cooler when the cooling efficiency becomes lower than a first determination value; and
reducing, by the exhaust gas recirculation system, an amount of the recirculated gas when the cooling efficiency for cooling the recirculated gas becomes lower than a second determination value lower than the first determination value.
